(19) United States
(12) Patent Application Publication
(10) Pub. No.: US 2023/0084257 A1
(43) Pub. Date: Mar. 16, 2023

(54) ARTIFICIALLY INTELLIGENT SYSTEM FOR DYNAMIC INFRASTRUCTURE MANAGEMENT IN EDGE SYSTEMS

(71) Applicant: INTERNATIONAL BUSINESS MACHINES CORPORATION, ARMONK, NY (US)

(72) Inventors: John S. Werner, Fishkill, NY (US); John Torok, Poughkeepsie, NY (US); Arkadiy O. Tsfasman, Wappingers Falls, NY (US); Noah Singer, White Plains, NY (US); Budy Notohardjono, Poughkeepsie, NY (US)

(21) Appl. No.: 17/447,516

(22) Filed: Sep. 13, 2021

(51) Int. Cl. G07C 5/00; B60W 60/00; G01S 19/42; G08G 1/14

(52) U.S. Cl. CPC G07C 5/008; B60W 60/001; G01S 19/42; G08G 1/142

(57) ABSTRACT

Artificially intelligent and dynamic infrastructure management in edge systems is provided. A number of available autonomous compute, networking, and/or cloud vehicles (ACNCV) is determined. Current conditions are extracted within an area in which the available ACNCV is defined to operate. Based on repositioning being needed, repositioning one or more of the available ACNCVs to a location last occupied under similar conditions. Based on the repositioning improving utilization, updating the ACNCV location in a database indicating improvement under current conditions. Location optimization is performed, including plotting a GPS location for each user, weighting each user based on individual utilization, resulting in a weighted k-means clustering to locate one or more centroids, locating in the database an allowable parking area closest to the one or more centroids, calculating a minimum movement among each of the ACNCVs to the allowable parking area, and transmitting repositioning instructions to a selected ACNCV.

### BACKGROUND

Embodiments of the present invention generally relate to computer systems, and more specifically to edge computing.

Edge computing is a distributed computing framework that brings enterprise applications closer to data sources, such as IoT devices or local edge servers. The proximity to data at its source may deliver strong benefits, including faster insights, improved response times, and better bandwidth availability.

It would be advantageous to adapt and move fixed resources in a computer system closer to locations of higher data usage for improved bandwidth utilization and improved response times.

### SUMMARY

Artificially intelligent and dynamic infrastructure management in edge systems is provided. A number of available autonomous compute, networking, and/or cloud vehicles (ACNCV) is determined. Current conditions are extracted within an area in which the available ACNCV is defined to operate. Based on repositioning being needed, repositioning one or more of the available ACNCVs to a location last occupied under similar conditions. Based on the repositioning improving utilization, updating the ACNCV location in a database indicating improvement under current conditions. Location optimization is performed, including plotting a GPS location for each user, weighting each user based on individual utilization, resulting in a weighted k-means clustering to locate one or more centroids, locating in the database an allowable parking area closest to the one or more centroids, calculating a minimum movement among each of the ACNCVs to the allowable parking area, and transmitting repositioning instructions to a selected ACNCV.

Additional features and advantages are realized through the techniques described herein. Other embodiments and aspects are described in detail herein. For a better understanding, refer to the description and to the drawings.

### BRIEF DESCRIPTION OF THE SEVERAL VIEWS OF THE DRAWINGS

The subject matter which is regarded as the present invention is particularly pointed out and distinctly claimed in the claims at the conclusion of the specification. The foregoing and other features and advantages are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 is a functional block diagram of an illustrative system for dynamic infrastructure management in edge systems, according to an embodiment of the invention;

FIG. 4 is a flowchart of an illustrative system for dynamic infrastructure management in edge systems, according to an embodiment of the invention;

FIG. 5 is a flowchart of an illustrative system for the operation of the AI location optimization module, according to an embodiment of the invention;

FIG. 6 illustrates an example of ACNCVs 310 being distributed in a geographic region; and

FIG. 7 illustrates an exemplary computing device 700 applicable for executing the method of FIGS. 4-5.

### DETAILED DESCRIPTION

The present disclosure relates generally to the field of user computing technologies, and in particular to dynamic infrastructure management in edge systems.

Edge datacenters are generally smaller facilities located close to the populations, the end users, that they serve. The edge datacenters are generally in a fixed location once they are established, and are typically connected to one or more larger central data centers. By processing data and services as close to the end user as possible, edge computing allows organizations to reduce latency and improve the customer experience.

Although they are scalable, it is expensive, time consuming, and therefore not generally practical to move edge datacenters in response to changing user patterns and utilization over time. Another challenge with edge computing is finding an optimal way to distribute resources within a dynamic environment. For example, a first location (e.g., work office) may have high data usage between the hours of 9 AM-5 PM, but the first location usage declines to a minimal data usage around 5 PM, as the higher data usage shifts to a second location after 5 PM, and a third location after 12 AM. Planning for this predictable and measurable shifting in demand tends to create additional planning, expense for systems, real estate, and resources to support the pattern of utilization at the systems. Although, in this example, the edge datacenters may adapt and reallocate resources, typically the reallocations consist of moving workloads, which may result in a workload moving to a core datacenter that is distant from the demand, and which may increase bandwidth latency. It may therefore be advantageous to bring resources closer to areas of high utilization to improve response times overall within the network.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

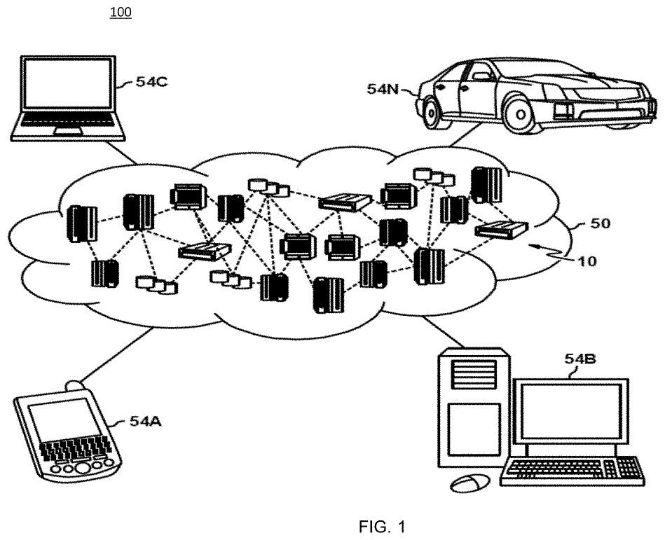

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

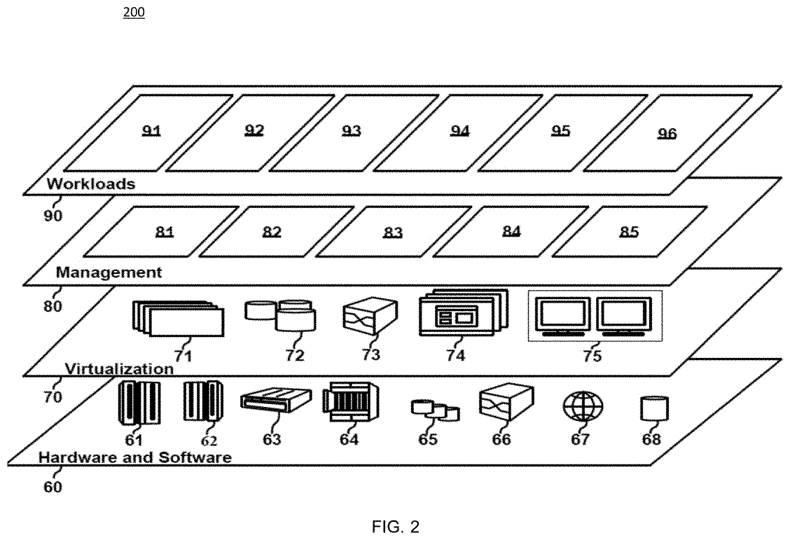

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dynamic infrastructure management in edge systems 96.

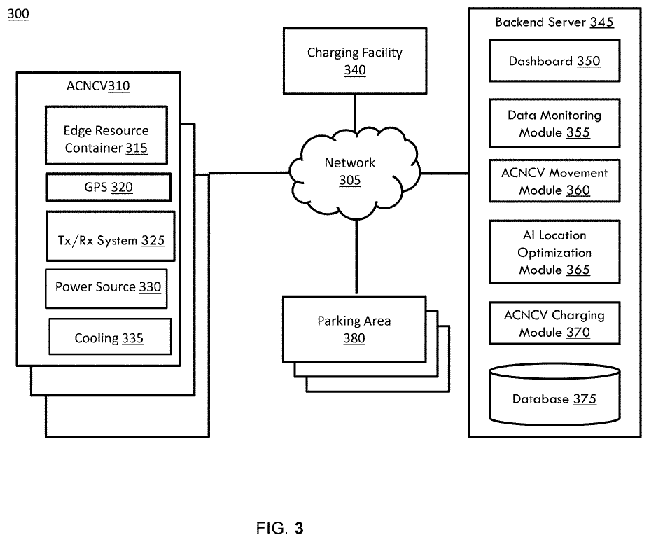

FIG. 3 is a functional block diagram 300 of an illustrative system for dynamic infrastructure management in edge systems, according to an embodiment of the invention.

The system 300 includes one or more autonomous compute, networking, and/or cloud vehicles (ACNCVs) 310, a charging facility 340, a backend server 345, and one or more parking areas 380 all interconnected via wired and/or wireless network 305.

The network 305 may comprise any communication protocol that allows data transfers between components of the ACNCVs 310, such as Wi-Fi, Bluetooth, Ethernet, or 3G (and other compatible versions).

Each ACNCV 310 includes an edge resource container 315, a GPS 320, a Tx/Rx system 325, a power source 330, and cooling 335.

In preferred embodiments, each ACNCV 310 is autonomous and receives instructions on whether and where to relocate from the ACNCV movement module 360 of the backend server 345.

In alternate embodiments, rather than being autonomous, one or more of the ACNCVs 310 may be relocated manually by a driver that receives instructions from the ACNCV movement module 360 of the backend server 345.

The edge resource container 315 may be considered to be a portable mobile container in which operable computer system components are assembled to provide edge resources. These resources include, but are not limited to, compute servers, storage servers, networking components, a data link, power supply link, and cooling system.

The AI location optimization module 365 determines the desired location for relocation, and transmits the desired location to the ACNCV movement module 360. Based on the desired location, the ACNCV movement module 360 calculates instructions to relocate the ACNCV 310, which uses the GPS 320 as an input to navigate to the desired location.

The GPS 320 may connect to an external server to obtain route information from such resources as Google Maps, Apple Maps, and similar navigation resources.

The Tx/Rx (transmit/receive) system 325 may include one or more antennas that allow for data transmission over the network 305 using wired protocols, wireless protocols, or a combination thereof. Through the Tx/Rx system 325, users may send/receive data to/from an edge resource container 315. In this context, users include users of applications that are hosted on the ACNCV 310, and users of the ACNCV 310, itself. The ACNCV movement module 360 communicates with the ACNCV 310 and provides movement instructions using the Tx/Rx system 325.

The power source 330 is used to power all components of the ACNCV 310, such as batteries and generators.

Cooling 335 is used to cool all components of the ACNCV 310, and may be powered by the power source 330. Here, cooling may include water cooling, fans, and computer room air condition.

The charging facility 340 is used to recharge the power source 330, such as the batteries, on the ACNCV 310. The charging facility 340 may include either a warehouse, a public electric vehicle charging facility, or both.

The backend server 345 may include a dashboard 350, a data monitoring module 355, the ACNCV movement module 360, the AI location optimization module 365, the ACNCV charging module 370, and the database 375.

Backend server 345 may be hosted on any server upstream from the edge resource layer and is preferably part of the core infrastructure in a datacenter.

Through the dashboard 350, users of the ACNCVs 310 may view current data usage across the network, the position of all ACNCVs 310, utilization trends, battery levels, and/or a predicted upcoming movement of one or more of the ACNCVs 310. The users in this context may be considered administrative users (administrators) who manage the backend server 345 to manage the resources, assets, and performance of the ACNCV 310. In some embodiments, drivers of a non-autonomous ACNCV 310 may access the dashboard 350 to view instructions from the ACNCV movement module 360 for relocating the ACNCV 310.

The data monitoring module 355 performs real-time analysis of utilization across all ACNCVs 310 under different conditions. This data is used as input by the AI location optimization module 365. The data monitoring module 355 may extract utilization data that is being tracked on the ACNCV 310 as part of its operation. Such tracked utilization data includes logs, typically of the processes and applications that the operating system creates and makes available for performance analysis. Applications perform similar logging, with the processes typically being associated with individual users. Most devices, such as tablets and phones, have this ability built in as well for tracking location, data usage per application, and similar metrics. Therefore, if utilization data were not tracked on the ACNCV 310, it could be extracted from the user device and sent to the ACNCV 310 as the user leaves/closes the application.

Condition data may be extracted from external devices not shown in network diagram 100 (e.g., date, time, weather data from sensors and/or servers that list information on local events, traffic data, local news, etc.).

As an example, the data monitoring module 355 may learn that when there is nice weather, an ACNCV may be positioned near outdoor locations, such as parks, and shops, to support the compute needs of visitors, tourists, and vendors. On the other hand, an ACNCV is not needed in those locations when the weather is inclement. The data monitoring module 355 may have access to weather data through various online real-time streams. Alternatively, sensors to monitor temperature, humidity, light intensity, liquid, and other condition data, may be installed on the ACNCV 310.

As another example, the data monitoring module 355 may determine that more ACNCVs should be positioned near a location where local events such as a fair, sporting event, or concert, are regularly scheduled, but those locations are not as populated when no event is in progress. The data monitoring module 355 may monitor various websites, such as those that local magazines and newspapers publish, as well as local community websites, and local radio and news stations. Since this may simply be monitoring of those sources, partnership with those sources/companies to implement this invention is not required.

In another example, local news or traffic data may show that when there is an accident at a given intersection, user movement patterns change. As in the previous example, the data monitoring module 355 may use the data to adapt and delay and/or change movement of ACNCVs 310.

The ACNCV movement module 360 receives output from the AI location optimization module 365 to send communication messages to the ACNCVs 310 when a change in position is determined. The communication messages may be provided as program instructions indicating where to move.

ACNCV movement module 360 also takes input from ACNCV charging module 370 to send communication messages to the ACNCVs when they need to leave their position to recharge at charging facility 340.

ACNCV movement module 360 accesses database 375 for allowable locations where an ACNCV 310 may operate. System operators may program allowable locations, which may include public locations or areas where the ACNCVs 310 are permitted operation by agreement with the property owners.

In one or more embodiments, an ACNCV 310 may operate continuously, i.e., drive continuously, while operating based in instructions from ACNCV movement module 360.

The AI location optimization module 365 uses input from data monitoring module 355 and the positions of the ACNCVs 310 to determine which areas have high utilization such that one or more ACNCVs 310 can be rerouted/repositioned to provide additional resources closer to the end users to provide a better experience (e.g., using Kubernetes).

The output of AI location optimization module 365, such as movement directing program instructions, is sent to ACNCV movement module 360 to reposition ACNCVs 310 if necessary.

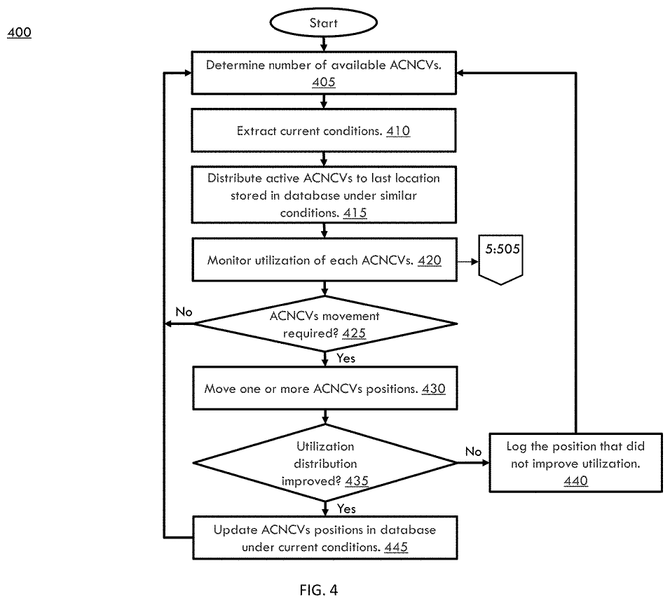

In preferred embodiments, the ACNCV 310 will be directed to move only if it is predicted to be needed in a location for a threshold amount of time (e.g., high utilization expected for >=3 hours). The operation of the AI location optimization module 365 is described more fully with respect to FIG. 4. Additional or alternate metrics may be considered in determining ACNCV 310 movement, such as end user latency times, bandwidth, and similar performance metrics.

The ACNCV charging module 370 monitors the power source 330 of all ACNCVs 310 to determine when an ACNCV 310 can be out of service and moved to charging facility 340. This action would send a notification to the AI location optimization module 365 such that the remaining ACNCVs 310 can be repositioned to account for the ACNCV 310 that is temporarily out of service for recharging. The direction may include program instructions transmitted to the AI location optimization module 365 once the battery level falls below a threshold that is based on the distance of the ACNCV 310 from the charging facility 340. This ensures the availability of enough power for the ACNCV 310 to drive to the charging facility 340. In that case, the remaining ACNCVs 310 are repositioned to account for the ACNCV 310 that was taken offline.

The database 375 includes past utilization data extracted by the data monitoring module 355, the ACNCV 310 positioning data, allowable parking areas 380, and the boundaries of the overall area where coverage is needed by a fleet of ACNCVs 310, such as city, town, campus, and similar. The past utilization data may include the number of processing instructions, an amount of resources used, CPU clock cycles, and similar utilization data.

The parking areas 380 may include any locations where an ACNCV 310 is allowed to park. Such locations may include, but are not limited to, public parking lots, college and/or work campuses, street parking, and similar locations. It may be noted that contractual agreements and methods of payment may be negotiated between owners of one or more of the parking areas and the owner/operators of the ACNCVs 310 to provide access to a parking area. In one or more embodiments, a charging facility 340 may also be a parking area 380.

FIG. 4 is an exemplary flowchart 400 of an illustrative system for dynamic infrastructure management in edge systems.

At block 405, each ACNCV 310 notifies the AI location optimization module 365 when it enters or leaves a given service area. In this way, the AI location optimization module 365 may determine the number of available ACNCVs 310 that are in service across a given area (e.g., city, campus, etc.). An ACNCV 310 may be out of service if it needs repair, is navigating to a new location, is charging, or taken out of service because it is not needed based on current workload. Additionally, this step may extract data detailing the resources and capabilities available on each ACNCV 310, since the ACNCVs 310 may vary in amount of storage or CPU for example. The AI location optimization module 365 may interrogate a log that each ACNCV 310 maintains to discover the available resources. Alternatively, or in addition, the log may be stored in the database 375.

At block 410, the AI location optimization module 365 extracts the current conditions in the area of the ACNCVs 310, using for example, various external devices and sensors. Current conditions include, but are not limited to, time of day, time of year, weather, scheduled local event, traffic conditions, and local news.

At block 415, active ACNCVs 310, i.e., those that are able to reposition and provide service, are distributed to the last location stored in database 375 under similar conditions that were extracted at block 410. The database 375 contains a log of past conditions and the locations of the ACNCVs 310 at that time. The number of overlapping conditions can be compared and thresholds may be assigned for some of those conditions. For example, for a day of week condition, a threshold may include buckets for either weekday, weened, or holiday. For weather conditions, the threshold may be a temperature, humidity, and precipitation vs. a degree of cloud, vs. a degree of sun. For time of day, a threshold may be defined within +/−1 hour). Other conditions may include that an event is within a threshold distance and the expected size of the event having a threshold number of attendees. The closest matching to these conditions may be selected to deploy the ACNCVs 310 at block 410.

If similar conditions do not exist, ACNCVs 310 may be distributed based on an alternate set of conditions that is closest to the current conditions, such as there being an existing database entry that meets two out of three conditions with the same number of ACNCVs 310. The AI location optimization module 365 will learn new positioning for the current conditions to continuously build and update the database 375.

At block 420 the utilization of each ACNCV 310 is monitored. Additional or alternate metrics may be considered in determining ACNCV 310 movement, such as end user latency times, bandwidth, and similar performance metrics.

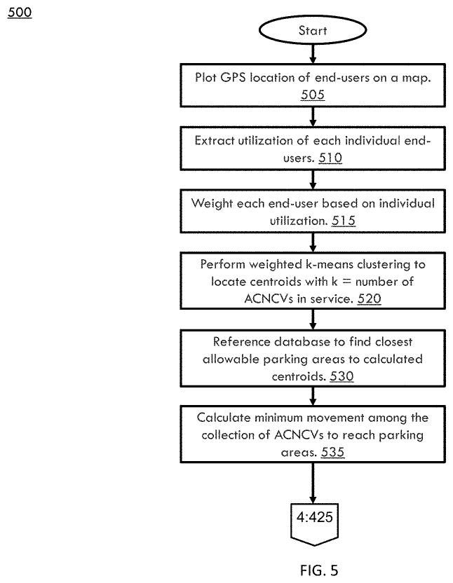

FIG. 5 is an exemplary flowchart 500 of the operations the AI location optimization module 365 executes to determine which areas have high utilization. In this way, one or more ACNCVs 310 can be repositioned to provide an improved user experience by moving additional resources closer to the demand. FIG. 5 is entered from block 420 of FIG. 4. Weighted k-means clustering is used to explain how the ACNCVs 310 determine an optimal position.

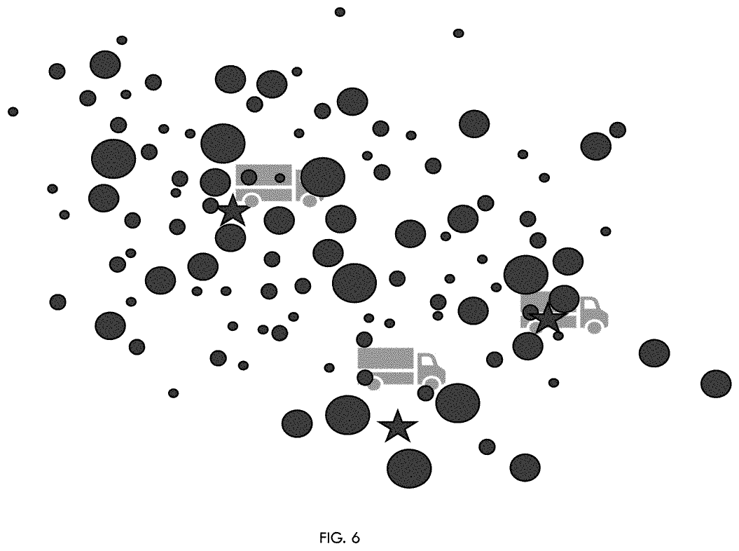

For example, FIG. 6 shows a small example where 3 ACNCVs 310 are distributed in a geographic region. The size of the data points indicates the utilization of each end user of hosted applications on the ACNCVs 310. The stars represent the calculated centroids, and the ACNCVs 310 are at the closest available parking area 380 to the centroids.

This method can be executed to predict movement based on historical data under similar conditions. The method could calculate the desired positions of all the ACNCVs 310 for the next x hours (e.g., x=3 hours, 12 hours, 24 hours, etc.).

At block 505, the AI location optimization module 365 plots the GPS location of end users on a map. The utilization of each individual end user is extracted at block 510. Each end user is weighted based on individual utilization 515. At block 520, weighted k-means clustering is performed to locate centroids with k=number of ACNCVs 310 in service. At block 530, the AI location optimization module 365 references the database 375 to find the closest allowable parking areas 380 to calculated centroids. At block 535, the AI location optimization module 365 calculates the minimum movement among the collection of ACNCVs 310 to reach parking areas 380.

Returning now to FIG. 4, at block 425 the AI location optimization module 365 determines if moving an ACNCV 310 will exceed a predicted utilization improvement threshold, such as 5%.

Several conditions, if met, may require movement. For example, movement may be required if utilization on one or more ACNCVs 310 is above a high utilization threshold (e.g., >=80%) and one or more other ACNCVs 310 are below a utilization threshold (e.g., <=20%). Movement may also be required if utilization across all ACNCVs 310 is not balanced (e.g., all ACNCVs 310 are not within 10% utilization of each other). Additionally, movement may be required if a known condition is upcoming (e.g., a scheduled sporting event, concert, end of the workday where many user's physical position will change, etc.) or a new event was detected on the current loop iteration (e.g., it started raining so users are leaving parks and other outdoor gathering areas). Known upcoming conditions may trigger prior to the event and take travel time into account.

If movement is required, at block 430 one or more ACNCVs 310 change position. An example of a change in position may be that the ACNCV 310 moves to the next closest allowable parking area 380 towards other ACNCVs 310 that have higher utilization. An ACNCV 310 may periodically attempt to move to the next closest allowable parking area 380 to determine if utilization increases which would indicate that a more optimal position has been found under the current conditions. Multiple ACNCVs 310 may migrate to accommodate one ACNCV 310 that fell below a utilization threshold. For example, a first ACNCV 310 at a first location is 40 minutes from a second location. Rather than move from the first location to the second location, the first ACNCV 310 may move to a third location that is 15 minutes away and a second ACNCV 310 that is currently at the third location will move to the second location that is 20 minutes away. The simultaneous movement will get all ACNCVs 310 to the optimal position within 20 minutes rather than 40 minutes. The log, mentioned at block 440, is checked to ensure an ACNCV 310 does not continuously attempt moving to the same locations that have recently been attempted.

At decision block 435, the AI location optimization module 365 determines if utilization (or any other desirable metrics) has improved. This is done by comparing utilization at the previous location to utilization at the new position.

If utilization has not improved (block 435 “No” branch), the method moves to block 440 to log the position that did not improve the utilization before looping back to block 405. This position is logged such that a new position can be attempted on the next pass through the process. An ACNCV 310 may attempt a threshold number (e.g., 5, 10, etc.) of repositions before exiting the loop and parking at the spot with the highest utilization out of the positions that were attempted. Alternatively, there may be no threshold reposition attempts and the ACNCVs 310 will continue to move until optimizing utilization across the given area.

If utilization has improved (block 435 “Yes” branch), the new position of ACNCV 310 is logged to database 375 under the current conditions before the method loops back to block 405 to continue monitoring.

Returning to block 425, if movement is not required, processing returns to block 405.

Through the continuous monitoring of method 400, ACNCVs 310 learn optimal placement and optimal migration within the given boundaries (e.g., city, town, campus) under different conditions to provide the best experience to end users for one or more of compute, networking, and/or cloud storage to reduce latency and increase bandwidth.

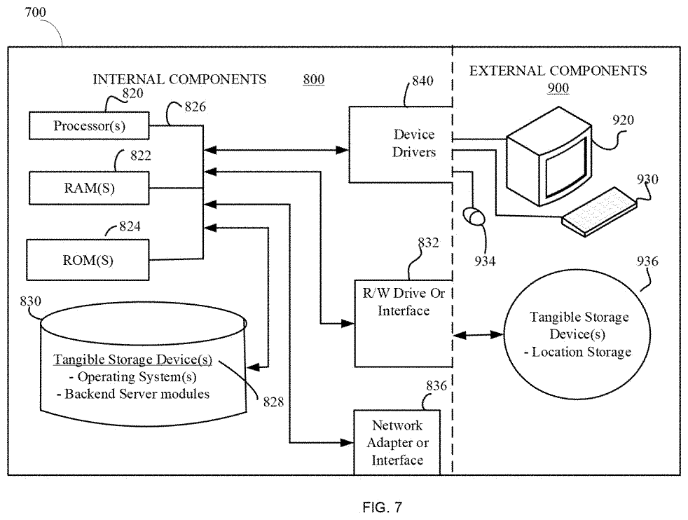

FIG. 7 illustrates an exemplary computing device 700 applicable for executing the algorithm of FIGS. 4-5. Computing device 700 may include respective sets of internal components 800 and external components 900 that together may provide an environment for a software application. Each of the sets of internal components 800 includes one or more processors 820; one or more computer-readable RAMs 822; one or more computer-readable ROMs 824 on one or more buses 826; one or more operating systems, backend server modules (dashboard 350, data monitoring 355, ACNCV movement 360 AI location optimization 265, and ACNCV charging 370) 828 executing the algorithm of FIGS. 4-5; and one or more computer-readable tangible storage devices 830. The one or more operating systems 828 are stored on one or more of the respective computer-readable tangible storage devices 830 for execution by one or more of the respective processors 820 via one or more of the respective RAMs 822 (which typically include cache memory). In the embodiment illustrated in FIG. 7, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 also includes a R/W drive or interface 832 to read from and write to one or more computer-readable tangible storage device(s) 936 such as a CD-ROM, DVD, SSD, USB memory stick, and magnetic disk. In FIG. 7, tangible storage device(s) includes storage for a database 375 in which is stored the location data, among other information.

Each set of internal components 800 may also include network adapters (or switch port cards) or interfaces 836 such as a TCP/IP adapter cards, wireless WI-FI interface cards, or 3G or 4G wireless interface cards or other wired or wireless communication links. The operating system 828 that is associated with computing device 700, can be downloaded to computing device 700 from an external computer (e.g., server) via a network (for example, the Internet, a local area network, or other wide area network) and respective network adapters or interfaces 836. From the network adapters (or switch port adapters) or interfaces 836 and operating system 828 associated with computing device 700 are loaded into the respective hard drive 830 and network adapter 836.

External components 900 can also include a touch screen 920 and pointing devices 930. The device drivers 840, R/W drive or interface 832 and network adapter or interface 836 comprise hardware and software (stored in storage device 830 and/or ROM 824).

Various embodiments of the invention may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although preferred embodiments have been depicted and described in detail herein, it will be apparent to those skilled in the relevant art that various modifications, additions, substitutions and the like can be made without departing from the spirit of the disclosure, and these are, therefore, considered to be within the scope of the disclosure, as defined in the following claims.

What is claimed is:

1. A method comprising:
determining a number of available autonomous compute, networking, and/or cloud vehicles (ACNCV);
extracting current conditions within an area in which the available ACNCV is defined to operate;
based on repositioning being needed, repositioning one or more of the available ACNCVs to a location last occupied under similar conditions; and
based on the repositioning improving utilization, updating the ACNCV location in a database indicating improvement under current conditions.

2. The method of claim 1, wherein the ACNCV operates within the defined area, and wherein the ACNCV notifies an ACNCV management system upon entering and upon leaving the defined area.

3. The method of claim 1, wherein repositioning the one or more of the available ACNCVs moves additional computing resources closer to demand.

4. The method of claim 1, wherein based on a predicted utilization being less than a configurable threshold, the ACNCV is not repositioned.

5. The method of claim 1, wherein the current conditions within the defined area are compared to similar conditions, and wherein the ACNCV repositions based on the resulting comparison meeting one or more configurable thresholds.

6. The method of claim 1, wherein the ACNCV repositions itself in response to receiving program instructions transmitted from an ACNCV management system.

7. The method of claim 1, further comprising:
plotting a GPS location of each user;
weighting each user based on individual utilization, resulting in a weighted k-means clustering to locate one or more centroids;
the ACNCV management system locating in the database an allowable parking area closest to the one or more centroids;
calculating a minimum movement among each of the ACNCVs to the allowable parking area; and
transmitting repositioning instructions to a selected ACNCV.

8. A computer program product, wherein the computer program product comprises a computer readable storage medium having program instructions embodied therewith, the program instructions executable by a processing unit to cause the processing unit to perform a method comprising:
determining a number of available autonomous compute, networking, and/or cloud vehicle (ACNCV);
extracting current conditions within an area in which the available ACNCV is defined to operate;
based on repositioning being needed, repositioning one or more of the available ACNCVs to a location last occupied under similar conditions; and
based on the repositioning improving utilization, updating the ACNCV location in a database indicating improvement under current conditions.

9. The computer program product of claim 8, wherein the ACNCV operates within the defined area, and wherein the ACNCV notifies an ACNCV management system upon entering and upon leaving the defined area.

10. The computer program product of claim 8, wherein repositioning the one or more of the available ACNCVs moves additional computing resources closer to demand.

11. The computer program product of claim 8, wherein based on a predicted utilization being less than a configurable threshold, the ACNCV does not reposition.

12. The computer program product of claim 8, wherein the current conditions within the defined area are compared to similar conditions, and wherein the ACNCV repositions based on the resulting comparison meeting one or more configurable thresholds.

13. The computer program product of claim 8, wherein the ACNCV repositions itself in response to receiving program instructions transmitted from an ACNCV management system.

14. The computer program product of claim 8, further comprising:
plotting a GPS location of each user;
weighting each user based on individual utilization, resulting in a weighted k-means clustering to locate one or more centroids;
the ACNCV management system locating in the database an allowable parking area closest to the one or more centroids;
calculating a minimum repositioning among each of the ACNCVs to the allowable parking area; and
transmitting repositioning instructions to a selected ACNCV.

15. A computer system, comprising:
one or more processors; and a computer-readable memory coupled to the one or more processors, the computer-readable memory comprising instructions for:
determining a number of available autonomous compute, networking, and/or cloud vehicle (ACNCV);
extracting current conditions within an area in which the available ACNCV is defined to operate;
based on repositioning being needed, repositioning one or more of the available ACNCVs to a location last occupied under similar conditions; and
based on the repositioning improving utilization, updating the ACNCV location in a database indicating improvement under current conditions.

16. The computer system of claim 15, wherein the ACNCV operates within the defined area, and wherein the ACNCV notifies an ACNCV management system upon entering and upon leaving the defined area.

17. The computer system of claim 15, wherein repositioning the one or more of the available ACNCVs moves additional computing resources closer to demand.

18. The computer system of claim 15, further comprising:
plotting a GPS location of each user;
weighting each user based on individual utilization, resulting in a weighted k-means clustering to locate one or more centroids;
the ACNCV management system locating in the database an allowable parking area closest to the one or more centroids;
calculating a minimum movement among each of the ACNCVs to the allowable parking area; and
transmitting repositioning instructions to a selected ACNCV.

19. The computer system of claim 15, wherein the ACNCV repositions itself in response to receiving program instructions transmitted from an ACNCV management system.

20. The computer system of claim 15, wherein based on a predicted utilization being less than a configurable threshold, the ACNCV is not repositioned.
